(19) United States
(12) Patent Application Publication
(10) Pub. No.: US 2023/0385777 A1
(43) Pub. Date: Nov. 30, 2023

(54) SCHEDULING CALENDAR EVENTS

(71) Applicant: Microsoft Technology Licensing, LLC, Redmond, WA (US)

(72) Inventors: Yuchen LI, Redmond, WA (US); Cristina DAESCU, Woodinville, WA (US)

(73) Assignee: Microsoft Technology Licensing, LLC, Redmond, WA (US)

(21) Appl. No.: 17/804,441

(22) Filed: May 27, 2022

(51) Int. Cl. G06Q 10/10; G06Q 10/06

(52) U.S. Cl. CPC G06Q 10/1095; G06Q 10/063116

(57) ABSTRACT

A method for scheduling one or more of a plurality of calendar events comprises generating a plurality of partial candidate calendars for an attendee. Each partial candidate calendar includes, for each of one or more calendar events, a timeslot selected from one or more timeslot options for that calendar event. An opportunity cost is calculated for each partial candidate calendar. At least some of the partial candidate calendars are queued for further development in which each queued partial candidate calendar is a parent node in a calendar graph. The further development includes adding a calendar event to the parent node to thereby generate another partial candidate calendar or a completed candidate calendar. The queuing is sequenced based on the opportunity cost for each partial candidate calendar. At least a portion of the plurality of calendar events are scheduled using one or more completed candidate calendars generated from the queuing.

### BACKGROUND

Individuals may be invited to a plurality of different events, such as work meetings and social functions, that may conflict in time. It can be challenging to prioritize conflicting events, particularly when scheduling for multiple attendees. Among other difficulties, generating and evaluating potential solutions can be computationally expensive. Thus, a technical challenge exists to schedule conflicting calendar events.

### SUMMARY

To address the issues discussed above, a computing system is provided. The computing system comprises a processor; and a memory storing instructions executable by the processor. The instructions are executable to receive, as input a plurality of calendar events to be scheduled for an attendee. A plurality of partial candidate calendars are generated for the attendee. Each partial candidate calendar includes, for each of one or more calendar events of the plurality of calendar events, a timeslot selected from one or more timeslot options for that calendar event. An opportunity cost is calculated for each partial candidate calendar. At least some of the partial candidate calendars are queued for further development in which each queued partial candidate calendar is a parent node in a calendar graph for the attendee. The further development includes adding a calendar event of the plurality of calendar events to the parent node to thereby generate another partial candidate calendar or a completed candidate calendar that is a child node of the parent node. The queuing is sequenced based on the opportunity cost for each partial candidate calendar. At least some of the partial candidate calendars are further developed based on the queuing. At least a portion of the plurality of calendar events are scheduled for the attendee using one or more completed candidate calendars generated from the queuing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of a computing system for scheduling one or more calendar events according to an example embodiment of the subject disclosure.

FIG. 2 shows an example of partial candidate calendars that can be generated from the calendar events of FIG. 1.

FIG. 3 shows another example of partial candidate calendars that can be generated from the calendar events of FIG. 1.

FIG. 4 shows an example of a data structure that can be used to represent calendar events scheduled by the computing system of FIG. 1.

FIG. 5 shows an example of a calendar event that can be fractioned by the computing system of FIG. 1.

FIG. 6 shows an example of a partial multi-user candidate calendar for a plurality of attendees that can be generated from the calendar events of FIG. 1.

FIG. 7 shows an example of scheduling one or more calendar events for the attendees of FIG. 6.

FIGS. 8A-8B are a flowchart illustrating a method for scheduling one or more calendar events according to an example embodiment of the subject disclosure.

FIG. 9 shows a schematic diagram illustrating an example computing system according to an example embodiment of the subject disclosure.

### DETAILED DESCRIPTION

As introduced above, two or more different events, such as work meetings and social functions, may conflict in time. However, it can be challenging to prioritize one event or another when two or more events conflict. Further, it may be computationally expensive to generate permutations of the two or more events to evaluate as potential solutions for scheduling the two or more conflicting events.

Accordingly, examples are disclosed that relate to scheduling calendar events for an attendee. Briefly, a number of partial candidate calendars are generated for the attendee. At least some of these calendars are queued for further development to thereby generate, via adding additional events, one or more additional partial candidate calendars and/or one or more completed candidate calendars. The process of generating and evaluating the partial candidate calendars and completed candidate calendars is achieved via use of opportunity cost in a heuristic to build a graph of candidate calendars and evaluate potential solutions. In this manner, scheduling conflicts can be resolved or at least minimized, and one or more calendar events can be scheduled quickly and in a more computationally efficient manner than by constructing and evaluating complete candidate calendars by brute force. In addition, and as described in more detail below, this approach serves as a general case that can be extrapolated to schedule calendar events for a plurality of attendees.

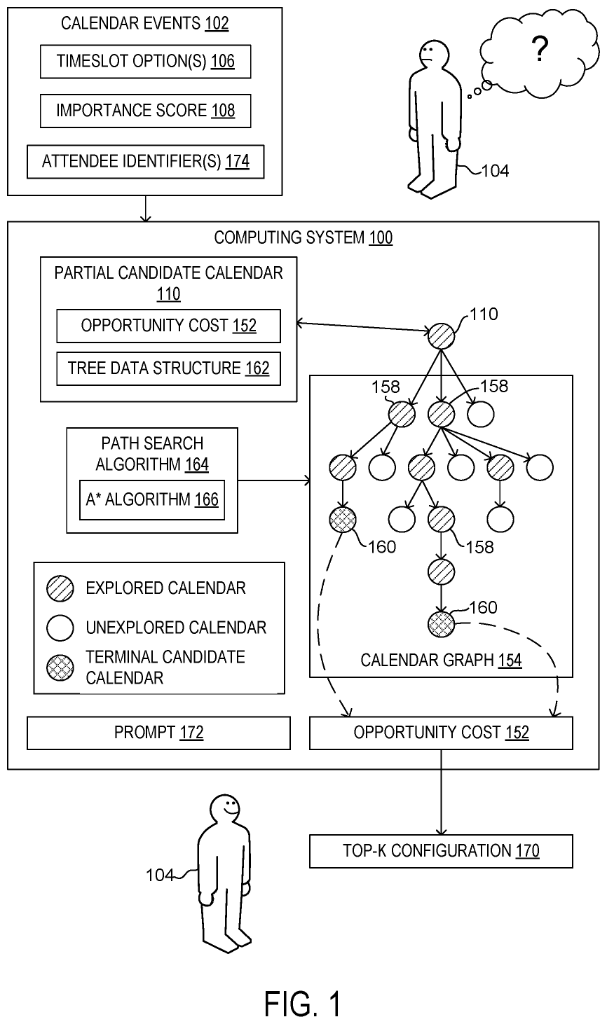

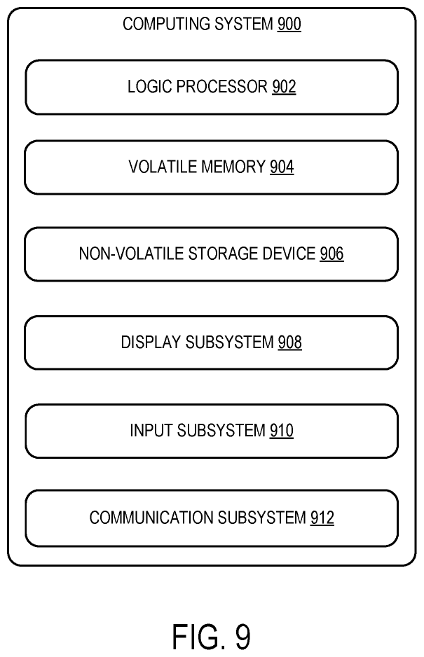

FIG. 1 shows an example of a computing system 100 for scheduling one or more of a plurality of calendar events. In some examples, the computing system 100 includes a server computing system (e.g., a cloud-based server or a plurality of distributed cloud servers). In other examples, the computing system 100 may include any other suitable type of computing system. Other examples of suitable computing systems include, but are not limited to, a desktop computer and a laptop computer. Additional aspects of the computing system 100 are described in more detail below with reference to FIG. 9.

The computing system 100 is configured to receive, as input, a plurality of calendar events 102 to be scheduled for an attendee 104. Each calendar event 102 of the plurality of calendar events 102 has one or more timeslot options 106. Each timeslot option 106 of the one or more timeslot options 106 represents a timeslot at which the calendar event 102 is permitted to be scheduled.

Each calendar event 102 of the plurality of calendar events is also associated with an importance score 108 for the attendee 104. The importance score 108 is a quantitative value (e.g., a number in the range of 0-1) that represents a relative importance of the attendee 104 attending the calendar event 102. For example, a calendar event having an importance score of 0.2 may be less important than another calendar event having an importance score of 0.9. In this manner, the importance score can be used to quantify the importance of attendee/meeting pairings.

The following paragraph provides an example of an input for the computing system 100.

```
[
  {
    “unique_id”: 123,
    “description”: “standup”,
    “start_options”: [2, 4],
    “duration”: 3,
    “importance_per_user”: [
      {“user_id”: 4, “importance”: 0.2},
      {“user_id”: 22, “importance”: 0.5},
      {“user_id”: 19, “importance”: 0.25},
      {“user_id”: 59, “importance”: 0.125}
    ]
  },
  {
    “unique_id”: 1000,
    “description”: “1:1 between users 4 and 22”,
    “start_options”: [3, 4, 6],
    “duration”: 1,
    “importance_per_user”: [
      {“user_id”: 4, “importance”: 0.3},
      {“user_id”: 22, “importance”: 0.7}
    ]
  },
  {
    “unique_id”: 2,
    “description”: “project meeting”,
    “start_options”: [2],
    “duration”: 1,
    “importance_per_user”: [
      {“user_id”: 4, “importance”: 1.0},
      {“user_id”: 22, “importance”: 1.0},
      {“user_id”: 59, “importance”: 0.5}
    ]
  },
  {
    “unique_id”: 800,
    “description”: “Focus time”,
    “start_options”: [6],
    “duration”: 1,
    “importance_per_user”: [
      {“user_id”: 22, “importance”: 0.9}
    ]
  },
]
```

In this example, four calendar events are proposed for an attendee: “standup”, “1:1 between users 4 and 22”, “project meeting”, and “Focus time”. Each calendar event has a unique identifier: “123”, “1000”, “2”, and “800”, respectively. Each calendar event also has one or more timeslot options, represented by variables “start options” and “duration”. For example, “standup” may begin at 2 PM or 4 PM, and lasts for 3 hours. Each calendar event also has a list of attendees invited to the calendar event, represented by the “user_id” variable. For example, users 4, 22, 19, and 59 are invited to standup. Importance scores of 0.2, 0.5, 0.25, and 0.125, respectively, are associated with the attendees. In this example, it is more important for user 22 than any other user to attend “standup”. However, it is more important for the user 22 to attend the “project meeting” than “standup”. Although attending both the “project meeting” and “standup” yields a higher sum of importance scores, and thus a lower opportunity cost, than attending one of these calendar events. Dedicated break time is, in some examples, represented as a meeting with a suitable importance score (e.g., an importance score in the range of 0-1). In this manner, the computing system can deduce flexibility of a calendar event from the one or more timeslot options, and urgency from the importance scores.

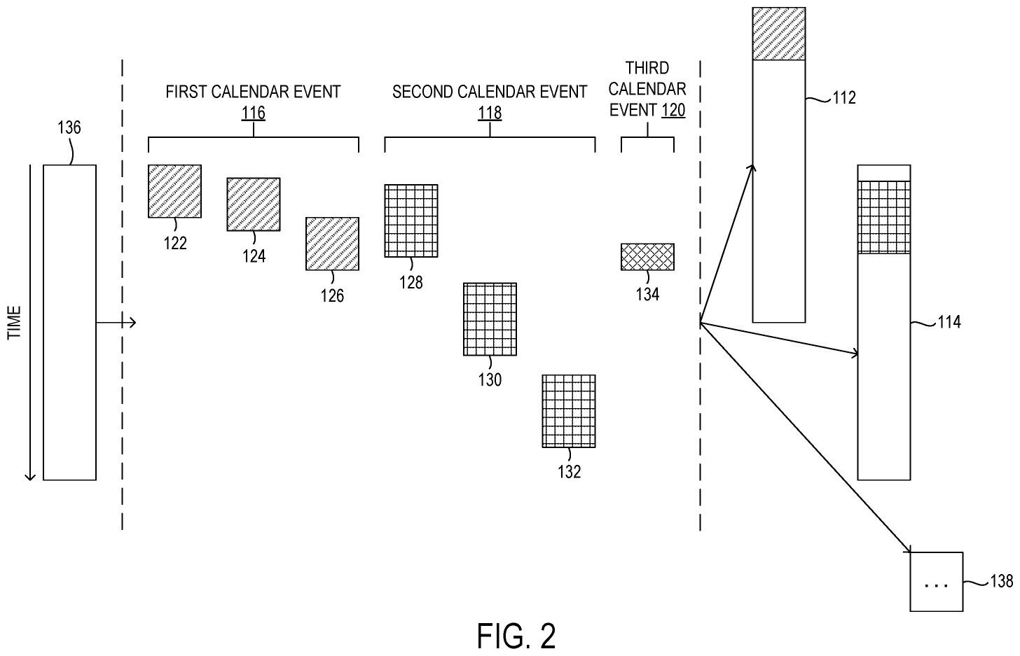

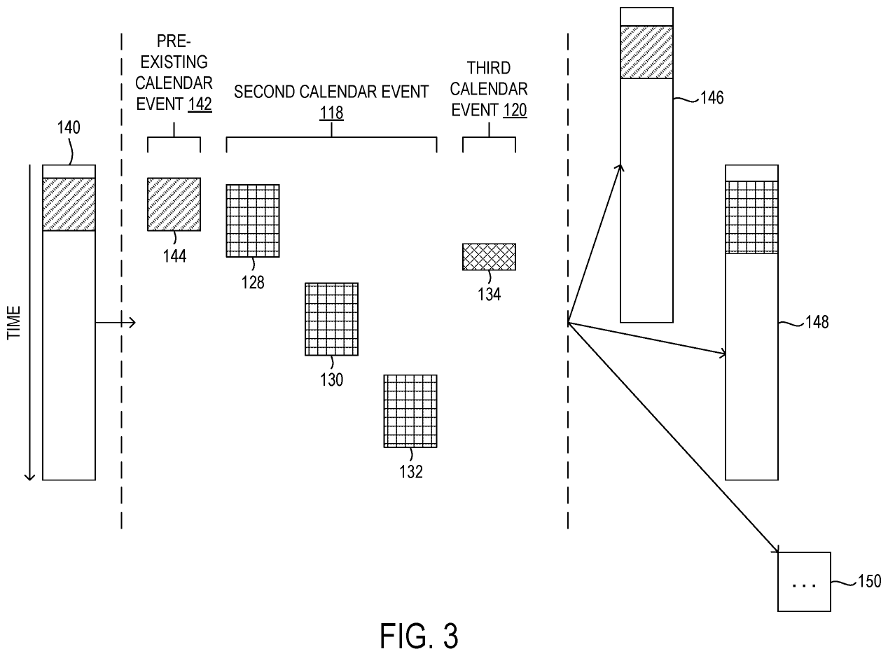

For a single attendee 104, the computing system 100 is configured to generate a plurality of partial candidate calendars 110. As described in more detail below with reference to FIGS. 2-3, each partial candidate calendar 110 includes, for each of one or more calendar events 102 of the plurality of calendar events 102, a timeslot selected from one or more timeslot options 106 for that calendar event 102.

FIG. 2 shows an example of a first calendar event 116, a second calendar event 118, and a third calendar event 120. The first calendar event 116 has a first timeslot option 122, a second timeslot option 124, and a third timeslot option 126. The second calendar event 118 has a first timeslot option 128 that conflicts with the three timeslot options 122, 124, 126 of the first calendar event 116. The second calendar event 118 also has a second timeslot option 130 and a third timeslot option 132 that do not conflict with the first calendar event 116. The third calendar event 120 has a single timeslot option 134 that conflicts with the third timeslot option 126 of the first calendar event 116 and the first timeslot option 128 of the second calendar event 118.

At least one timeslot is selected for each of at least one calendar event to generate a partial candidate calendar. As described in more detail below, each of the partial candidate calendars serves as a starting point for the computing system to generate and compare scheduling configurations for the plurality of calendar events. In the example of FIG. 2, a first partial candidate calendar 112 is generated by tentatively scheduling the first timeslot option 122 for the first calendar event 116 on an empty calendar 136 for the attendee 104. A second partial candidate calendar 114 is generated by tentatively scheduling the first timeslot option 128 for the second calendar event 118 on the empty calendar 136. In some examples, one or more additional partial candidate calendars 138 are generated in the same manner for other timeslot options (e.g., scheduling the second timeslot option 124 for the first calendar event 116) and/or other calendar events (e.g., the third calendar event 120). It will also be appreciated that, while the first candidate calendar 112 and the second candidate calendar 114 shown in the example of FIG. 2 include one calendar event, each partial candidate calendar may include a plurality of calendar events.

In other examples, and with reference now to FIG. 3, one or more partial candidate calendars are generated from a partially filled calendar 140 including at least one preexisting calendar event 142. Each preexisting calendar event 142 is treated as a calendar event having a single fixed timeslot option 144. A first partial candidate calendar 146 is generated by tentatively scheduling the single fixed timeslot option 144 for the preexisting calendar event 142. A second partial candidate calendar 148 is generated by tentatively scheduling the first timeslot option 128 for the second calendar event 118. As the first timeslot option 128 for the second calendar event 118 conflicts with the preexisting calendar event 142, the second partial candidate calendar 148 does not include the preexisting calendar event 142. In some examples, one or more additional partial candidate calendars 150 are generated for other timeslot options (e.g., the second timeslot option 130 for the second calendar event 118) and/or other calendar events (e.g., the third calendar event 120) as described above. In this manner, a plurality of partial candidate calendars 146, 148, 150 may be generated based upon the partially filled calendar 140.

With reference again to FIG. 1, the computing system 100 is configured to calculate an opportunity cost 152 for each partial candidate calendar 110. In some examples, the opportunity cost 152 for each partial candidate calendar 110 includes a sum of the importance scores 108 of each calendar event 102 not scheduled for the attendee 104, less the importance score 108 of each calendar event 102 scheduled for the attendee 104. For example, the opportunity cost of the first partial candidate calendar 112 of FIG. 2 is the importance score of the first calendar event 116 minus the importance score of the second calendar event 118 and the importance score of the third calendar event 120. As described in more detail below, the opportunity cost 152 serves as a heuristic to selectively generate one or more additional partial candidate calendars and to evaluate one or more completed candidate calendars based upon the importance of the calendar event(s) contained therein.

In some examples, the importance score 108 is scaled for a calendar event 102 having a plurality of different timeslot options 106. The importance of scheduling a meeting may increase as a number of opportunities to schedule the meeting diminish due to scheduling conflicts. Accordingly, and as described in more detail below, the importance score 108 for timeslot options later in a day (when there may be fewer remaining opportunities to schedule the meeting) may be scaled to reflect a greater opportunity cost than an earlier timeslot option (when there may be more timeslot options available later in the day).

The importance score 108 may be scaled in any suitable manner. In some examples, soft-max weighting is used to smooth out the opportunity cost of missing one or more timeslot options for a calendar event. For example, equation (1) represents a scaling factor that may be used to weigh the opportunity cost of missing the first timeslot option 128 for the second calendar event 118 of FIG. 2. Equation (2) represents a scaling factor that may be used to weigh the opportunity cost of missing the second timeslot option 130 of the second calendar event 118. Equation (3) represents a scaling factor that may be used to weigh the opportunity cost of missing the third timeslot option 132 of the second calendar event 118.

$$\frac{{γ}^{0}}{{\sum }_{i = 0}^{2} {γ}^{i}} \qquad ( 1 )$$

$$\frac{{γ}^{1}}{{\sum }_{i = 0}^{2} {γ}^{i}} \qquad ( 2 )$$

$$\frac{{γ}^{2}}{{\sum }_{i = 0}^{2} {γ}^{i}} \qquad ( 3 )$$

Here, γ represents a customizable temperature factor that governs how steeply the opportunity cost scales between the timeslot options. Equations (1)-(3) are equal when γ=1. In other examples, γ>1. In yet other examples, γ is greater than or equal to 10. This results in a smaller opportunity cost for skipping the first timeslot option 128 than the second timeslot option 130. Similarly, the second timeslot option 130 has a smaller opportunity cost than the third timeslot option 132. In this manner, the opportunity cost of the first timeslot option 128 reflects the ability of the attendee to accommodate the second timeslot option 130 or the third timeslot option 132 if the first timeslot option 128 is skipped. On the other hand, skipping the third timeslot option 132 results in a greater opportunity cost than skipping either the first timeslot option 128 or the second timeslot option 130.

With reference again to FIG. 1, the opportunity cost 152 is used to queue at least some of the partial candidate calendars 110 for further development. The further development of the partial candidate calendars 110 may, in some respects, be considered an ‘exploration’ of a calendar graph 154 in which further calendars are formulated so that they can be scored against alternatives with the opportunity cost mechanism. In the calendar graph 154, each queued partial candidate calendar 110 serves as a parent node. The further development of the parent node includes adding a calendar event 102 of the plurality of calendar events 102 to the parent node to thereby generate another partial candidate calendar 158 or a completed candidate calendar 160. As described in more detail below, a calendar is considered “complete” when that calendar cannot accommodate any additional calendar events. The completed candidate calendar 160 may or may not include all of the calendar events 102, and the completed candidate calendar 160 may or may not have the lowest opportunity cost 152. Each child node in the calendar graph 154 represents either one of the other partial candidate calendars 158 or one of the completed candidate calendars 160. As described in more detail below, the opportunity cost 152 is used as a heuristic to build the calendar graph 154 and evaluate different permutations of scheduling at least a portion of the plurality of calendar events 102.

Each node of the calendar graph 154 has an internal data structure that represents the one or more calendar events scheduled therein. In some examples, each partial candidate calendar 110, 158 and each completed candidate calendar 160 includes a tree data structure 162, such as a binary tree, representing the one or more calendar events scheduled therein. The tree data structure 162 represents an internal structure of a selected candidate calendar (represented by an individual node of the calendar graph 154), which is not to be confused with the structure of the calendar graph 154. The tree data structure 162 enables the computing system 100 to identify an order in which one or more of the calendar events 102 are scheduled within a selected candidate calendar.

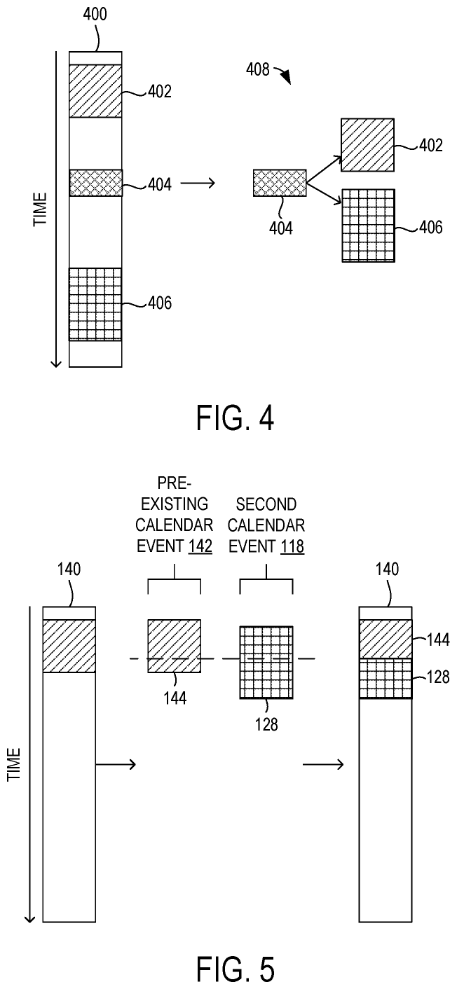

FIG. 4 shows an example of a selected candidate calendar 400. The selected candidate calendar may embody the partial candidate calendar 110, the partial candidate calendars 158, or the completed candidate calendar 160 of FIG. 1. The selected candidate calendar 400 includes a first calendar event 402, a second calendar event 404, and a third calendar event 406. The selected candidate calendar 400 is represented as a binary tree 408. The binary tree 408 indicates that the first calendar event 402 is scheduled before the second calendar event 404, and that the third calendar event 406 is scheduled after the second calendar event 404. In this manner, the binary tree 408 represents the structure of the selected candidate calendar 400.

Generating a completed candidate calendar 160 for every possible permutation of the plurality of calendar events 102 by brute force may be time-consuming and inefficient. In addition, computational expense may scale rapidly with the number of calendar events 102, as finding a route through the calendar graph 154 that yields the lowest opportunity cost 152 is NP-hard.

Accordingly, and in one potential advantage of the present disclosure, the queuing of the at least some of the partial candidate calendars 110 for further development is sequenced based on the opportunity cost 152 for each partial candidate calendar 110. As described in more detail below, sequencing the queue based upon the opportunity cost enables the computing system to prioritize generating and evaluating child nodes that lead to lower opportunity cost completed candidate calendars than other child nodes. In addition, the computing system may skip generating child nodes that lead to higher-opportunity-cost solutions than the prioritized child nodes, which reduces the computational expense of scheduling the one or more calendar events relative to the brute force approach.

In some examples, the queuing is sequenced based upon a path search algorithm 164. One example of a suitable path search algorithm includes, but is not limited to, an A*algorithm 166. The A*algorithm 166 is an informed search algorithm that aims to find a path from the parent node of the calendar graph 154 to a terminal node having a lowest cost (e.g., the opportunity cost 152). In the calendar graph 154, a child node is considered terminal when it represents a completed candidate calendar 160, in which no further calendar events may be scheduled. The A*algorithm 166 finds each completed candidate calendar 160 by maintaining a tree of paths originating at the parent node and extending those paths one edge at a time by adding a calendar event 102 of the plurality of calendar events 102 to an explored node until either all of the calendar events 102 are scheduled or the explored node does not fit any additional calendar events.

At each step of developing the calendar graph 154, the A*algorithm 166 chooses which nodes to explore and which to leave unexplored (thereby conserving computing resources). This determination is made based upon the opportunity cost of the explored node and an estimate of the opportunity cost required to reach a terminal node from the explored node. In this manner, the opportunity cost 152 is used as a heuristic to selectively build the calendar graph 154. This results in the identification of one or more completed candidate calendars 160 without requiring the exploration of every possible permutation of the plurality of calendar events 102.

At least a portion of the plurality of calendar events 102 are scheduled for the attendee 104 using one or more of the completed candidate calendars 160 generated from the queuing. In some examples, the one or more completed candidate calendars 160 are sorted by their opportunity cost 152. A top-k configuration 170 is selected from among the one or more completed candidate calendars 160 based on the opportunity cost 152, and at least the portion of the plurality of calendar events 102 are scheduled according to the top-k configuration 170. In this manner, the computing system 100 is configured to resolve scheduling conflicts based upon the opportunity cost.

The following paragraph provides an example of an output from the computing system 100 for a single attendee (e.g., user 22).

| -- user: 22 | |
|---|---|
| -------------------- | |
| > description | : project meeting |
| > start | : 2 |
| > duration | : 1 |
| > other attendees | : [4, 59] |
| -------------------- | |
| > description | : 1:1 between users 4 and 22 |
| > start | : 3 |
| > duration | : 1 |
| > other attendees | : [4] |
| -------------------- | |
| > description | : Focus time |
| > start | : 6 |
| > duration | : 1 |
| > other attendees | : [ ] |

Here, user 22 is scheduled to attend the “project meeting” at 2 PM for 1 hour with attendees 4 and 59, followed by “1:1 between users 4 and 22” for 1 hour at 3 PM with attendee 4. User 22 also has 1 hour of focus time at 6 PM with no other attendees.

Adding a meeting that has lower importance than other meetings to the input to the computing system, and which conflicts with the other meetings, results in no change in the computing system's recommendations. However, the opportunity cost will reflect the value of the lower-importance meeting if it is skipped. If the schedule is accommodating (e.g., the low-importance meeting does not conflict with the other meetings), even low-importance meetings may be scheduled.

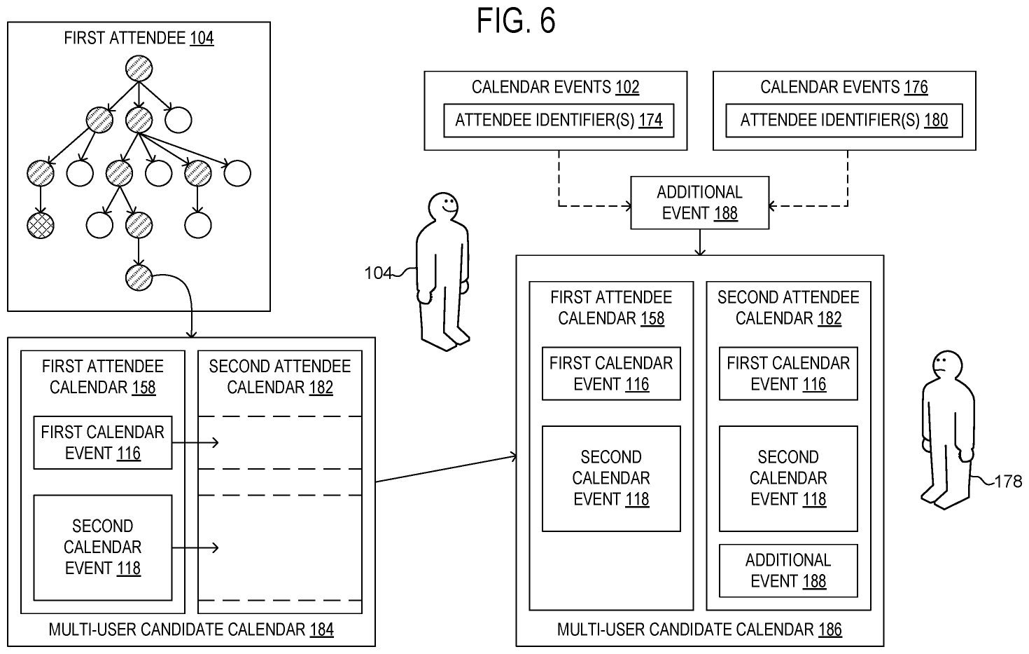

In some examples, the computing system 100 is configured to fraction a calendar event that conflicts with another calendar event. For example, FIG. 5 shows the partially filled calendar 140 of FIG. 3. As introduced above, the single fixed timeslot option 144 of the pre-existing calendar event 142 conflicts with the first timeslot option 128 of the second calendar event 118. Accordingly, in some examples, the computing system 100 fractions the pre-existing calendar event 142 and the second calendar event 118. In some examples, the computing system 100 is triggered to fraction the pre-existing calendar event 142 and the second calendar event 118 based at least upon a determination that the pre-existing calendar event 142 and the second calendar event 118 overlap in time. In other examples, the computing system 100 is additionally or alternatively configured to fraction the pre-existing calendar event 142 and the second calendar event 118 based upon any other suitable criteria, such as an importance score of the pre-existing calendar event 142 and the second calendar event 118 being greater than or equal to a threshold importance score (e.g., 0.9 out of 1.0). As illustrated by way of example in FIG. 5, fractioning the pre-existing calendar event 142 includes shortening the pre-existing calendar event 142 such that the pre-existing calendar event 142 ends before the attendee is scheduled to attend the second calendar event 118. In this example, fractioning the second calendar event 118 takes the form of dividing the second calendar event 118 in half, such that the attendee is scheduled to attend a later half of the second calendar event 118 and not an earlier half of the second calendar event 118. In this manner, the attendee may attend a portion of both calendar events.

In other examples, and with reference again to FIG. 1, the computing system 100 is configured to output, for each calendar event 102 not scheduled for the attendee 104, a prompt 172 for additional time slot options 106. In this manner, the attendee 104 or another user may provide alternative options that may enable the computing system 100 to schedule the calendar event 102.

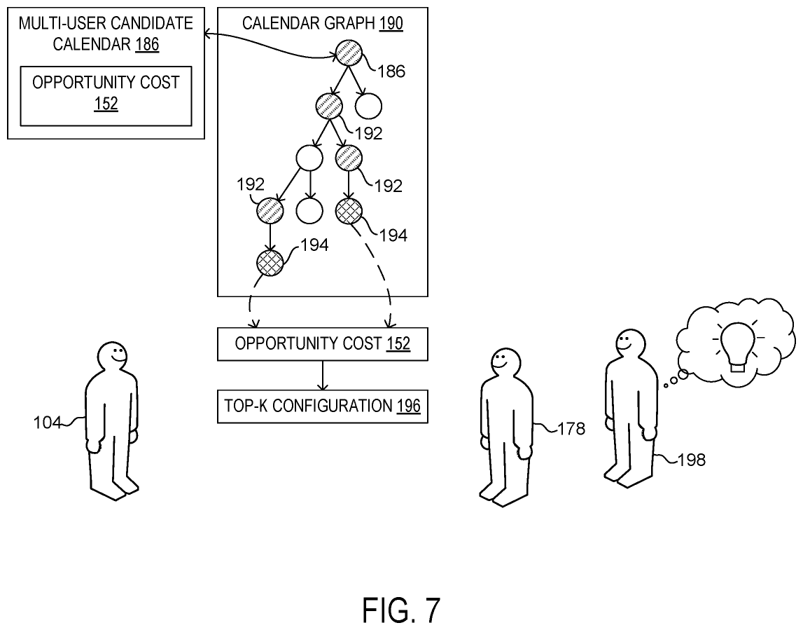

With reference now to FIG. 6, in some examples, the attendee 104 is a first attendee of two or more attendees. To obtain a list of the two or more attendees, the computing system 100 is configured to extract one or more attendee identifiers 174 from the plurality of calendar events 102 for the first attendee 104. For example, the “standup” event described above is associated with user identifiers 4, 22, 19, and 59. The “1:1 between users 4 and 22” is associated with user identifiers 4 and 22. The “project meeting” is associated with user identifiers 4, 22, and 59. “Focus time” is associated with user identifier 22. Thus, the list of attendee identifiers for the plurality of calendar events 102 is: 4, 19, 22, 59.

One or more other calendar events 176 are obtained that are associated with at least a second attendee 178 (e.g., the user 4). One or more other attendee identifiers 180 are extracted from the one or more other calendar events 176. For example, the user 4 may be invited to attend a concert with user 61, but not any of the other users 19, 22, and 59. Additional users 62 and 63 may also be invited to the concert. Thus, the list of attendee identifiers for the calendar events 102 and the calendar events 176 is: 4, 19, 22, 59, 61, 62, 63. In this manner, the list of attendees to be scheduled is assembled recursively up to a predetermined depth (e.g., 2 attendees). A configuration of one of the partial candidate calendars 158 for the first attendee 104 is forced onto a partial candidate calendar 182 associated with the second attendee 178, to thereby form a partial multi-user candidate calendar 184 associated with the first attendee 104 and the second attendee 178. The partial candidate calendar 158 for the first attendee 104 includes the first calendar event 116 and the second calendar event 118. In the partial multi-user candidate calendar 184, the computing system 100 cannot choose another timeslot option for the first calendar event 116 and the second calendar event 118 based upon the relative importance of these calendar events to the second attendee 178. Although, as described in more detail below, the partial multi-user candidate calendar 184 is still scored based upon the opportunity cost 152 for the second attendee 178. Forcing a selected calendar configuration for the first attendee onto the calendar for the second attendee allows the computing system to use the selected calendar configuration as a template to schedule at least a portion of the plurality of the calendar events 102, 176 for at least the second attendee 178, even though the configuration of the selected candidate calendar 158 for the first attendee 104 may not represent an optimal (e.g., minimum opportunity cost) schedule for the second attendee 178.

In some examples, the partial multi-user candidate calendar 184 at least temporarily restricts at least the second attendee calendar 182, such that the second attendee calendar 182 cannot be altered past the last calendar event (e.g., the second calendar event 118) of the first attendee calendar 158. This allows the computing system 100 to focus on a portion of the partial multi-user candidate calendar 184 without expending processing and storage resources generating and comparing permutations of calendar events that occur after the last calendar event of the first attendee calendar 158. After finding one or more solutions for the restricted partial multi-user candidate calendar 184, the computing system 100 removes the restriction. This enables the computing system 100 to further develop each solution.

It will also be appreciated that the “restriction” of at least the second attendee calendar 182 described above reflects one of many possible implementations. Any other suitable approach may be chosen to control which candidate calendar is “forced upon” which attendee. It will also be appreciated that any additional mechanisms other than the opportunity cost may be used to guide the further development and exploration of the calendar graph.

A plurality of additional multi-user partial candidate calendars 186 are generated for the first attendee 104 and the second attendee 178. Each additional multi-user partial candidate calendar 186 includes, in addition to calendar events of the forced configuration (e.g., the first calendar event 116 and the second calendar event 118 of the partial multi-user candidate calendar 184), one or more additional calendar events 188. In the example depicted in FIG. 6, the one or more additional calendar events 188 are added to the partial candidate calendar 182 associated with the second attendee 178. In other examples, the one or more additional calendar events 188 are added to the selected candidate calendar 158 for the first attendee 104, or to both the selected candidate calendar 158 for the first attendee 104 and the partial candidate calendar 182 associated with the second attendee 178. As described in more detail below, each of the additional multi-user partial candidate calendars 186 serves as a starting point for the computing system 100 to generate and compare scheduling configurations for the first attendee 104 and the second attendee 178.

In some examples, one or more of the additional calendar event(s) 188 are selected from the plurality of calendar events 102. In other examples, one or more of the additional calendar event(s) 188 are selected from the one or more other calendar events 176. It will be appreciated that, while the one or more other calendar events 176 may exclude the first attendee 104, the second attendee 178 may attend one or more events selected from the plurality of calendar events 102 for the first attendee 104.

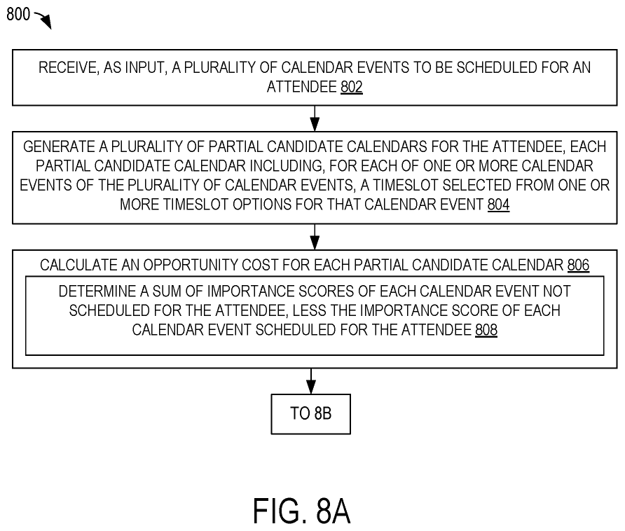

With reference now to FIG. 7, the opportunity cost 152 is computed for each additional multi-user partial candidate calendar 186. In some examples, the opportunity cost 152 for each additional multi-user partial candidate calendar 186 is a sum of the opportunity cost 152 for the first attendee 104 and the second attendee 178. Accordingly, the opportunity cost 152 considers the importance scores 108 of each calendar event to each attendee. It will also be appreciated that, in some examples, a high opportunity cost for one attendee is compensated by a low opportunity cost for another attendee.

At least some of the additional multi-user partial candidate calendars 186 are queued for further development. Like the development of the calendar graph 154 of FIG. 1, each queued additional multi-user partial candidate calendar 186 is a parent node in a multi-user calendar graph 190 for the first attendee 104 and the second attendee 178. The further development includes adding a calendar event to the parent node. Like the one or more additional calendar events 188 of FIG. 6, the calendar event that is added to the parent node is selected from one or more of the plurality of calendar events 102 of FIG. 1 or the one or more additional calendar events 176 of FIG. 2. This results in the generation of another partial multi-user candidate calendar 192 for the first attendee 104 and the second attendee 178 or a completed multi-user candidate calendar 194 for the first attendee 104 and the second attendee 178.

As described above for the calendar graph 154 of FIG. 1, the queuing of the at least some of the additional multi-user partial candidate calendars 186 is sequenced based on the opportunity cost for each partial multi-user candidate calendar for the first and second attendees. Like the queuing of the calendar graph 154 of FIG. 1, in some examples, the queuing applied to the multi-user calendar graph 190 is sequenced based upon an A*algorithm or another suitable path searching algorithm. This results in the identification of one or more completed multi-user candidate calendars 194 without requiring every possible permutation of the plurality of calendar events 102, 176 to be processed and/or stored in the memory of the computing system 100.

In some examples, at least a portion of the plurality of calendar events 102 are scheduled for the first attendee 104 and/or the second attendee 178 using one or more of the one or more completed multi-user candidate calendars 194 generated from the queuing. Like the one or more completed candidate calendars 160 of FIG. 1, in some examples, the one or more completed multi-user candidate calendars 194 of FIG. 7 are sorted by their opportunity cost 152. A top-k configuration 196 is selected from among the one or more completed multi-user candidate calendars 194 based on the opportunity cost 152. At least a portion of the plurality of calendar events 102 are then scheduled based upon the top-k configuration 196. In this manner, the computing system 100 is configured to resolve scheduling conflicts between the first attendee 104 and the second attendee 178 based upon the opportunity cost.

While the example described above with reference to FIGS. 6-7 refers to two attendees, it will also be appreciated that, in other examples, the computing system 100 is configured to generate one or more completed candidate calendars for at least a third attendee 198. For example, the computing system 100 may iteratively generate, queue, develop, and evaluate the multi-user candidate calendars 184 or 186 of FIGS. 6-7 to schedule at least a portion of the plurality of calendar events 102 and/or any other suitable calendar events (e.g., the one or more additional calendar events 176) for at least the third attendee 198.

The following paragraph provides an example of an output from the computing system 100 for a plurality of attendees (e.g., user 4, user 19, user 22, and user 59).

| === RANK: 0 === | |
|---|---|
| COST: −4.554545454545455 | |
| -- user: 4 | |
| -------------------- | |
| > description | : project meeting |
| > start | : 2 |
| > duration | : 1 |
| > other attendees | : [22, 59] |
| -------------------- | |
| > description | : 1:1 between users 4 and 22 |
| > start | : 3 |
| > duration | : 1 |
| > other attendees | : [22] |
| -------------------- | |
| > description | : standup |
| > start | : 4 |
| > duration | : 3 |
| > other attendees | : [19, 22, 59] |
| -- user: 19 | |
| -------------------- | |
| > description | : standup |
| > start | : 4 |
| > duration | : 3 |
| > other attendees | : [4, 22, 59] |
| -- user: 22 | |
| -------------------- | |
| > description | : project meeting |
| > start | : 2 |
| > duration | : 1 |
| > other attendees | : [4, 59] |
| -------------------- | |
| > description | : 1:1 between users 4 and 22 |
| > start | : 3 |
| > duration | : 1 |
| > other attendees | : [4] |
| -------------------- | |
| > description | : Focus time |
| > start | : 6 |
| > duration | : 1 |
| > other attendees | : [ ] |
| -- user: 59 | |
| -------------------- | |
| > description | : project meeting |
| > start | : 2 |
| > duration | : 1 |
| > other attendees | : [4, 22] |
| -------------------- | |
| > description | : standup |
| > start | : 4 |
| > duration | : 3 |
| > other attendees | : [4, 19, 22] |

The “RANK: 0” in the output indicates that this example represents the top-k schedule configuration for users 4, 19, 22, and 59 based upon the opportunity cost. The opportunity cost (e.g., “COST: −4.554545454545455”) is negative. This indicates that the users 4, 19, 22, and 59 collectively attend more meetings than those that are skipped.

The following paragraph provides another example of an input for the computing system 100. In the following example, a relatively important (e.g., having an importance score of 0.9 out of 1.0), immobile focus time is added for user 19.

```
[
  {
    “unique_id”: 123,
    “description”: “standup”,
    “start_options”: [2, 4],
    “duration”: 3,
    “importance_per_user”: [
      {“user_id”: 4, “importance”: 0.2},
      {“user_id”: 22, “importance”: 0.5},
      {“user_id”: 19, “importance”: 0.25},
      {“user_id”: 59, “importance”: 0.125}
    ]
  },
  {
    “unique_id”: 1000,
    “description”: “1:1 between users 4 and 22”,
    “start_options”: [3, 4, 6],
    “duration”: 1,
    “importance_per_user”: [
      {“user_id”: 4, “importance”: 0.3},
      {“user_id”: 22, “importance”: 0.7}
    ]
  },
  {
    “unique_id”: 2,
    “description”: “project meeting”,
    “start_options”: [2],
    “duration”: 1,
    “importance_per_user”: [
      {“user_id”: 4, “importance”: 1.0},
      {“user_id”: 22, “importance”: 1.0},
      {“user_id”: 59, “importance”: 0.5}
    ]
  },
  {
    “unique_id”: 800,
    “description”: “Focus time for user 22”,
    “start_options”: [6],
    “duration”: 1,
    “importance_per_user”: [
      {“user_id”: 22, “importance”: 0.9}
    ]
  },
  {
    “unique_id”: 800,
    “description”: “Focus time for user 19”,
    “start_options”: [6],
    “duration”: 1,
    “importance_per_user”: [
      {“user_id”: 19, “importance”: 0.9}
    ]
  },
]
```

As shown in the following example output from the computing system 100, the addition of the focus time for user 19 results in the computing system 100 suggesting user 19 skip standup to minimize the opportunity cost (e.g., by maximizing the sum of the importance scores of meetings attended by all of users 4, 19, 22 and 59).

| === RANK: 0 === | |
|---|---|
| COST: −3.2807292218124204 | |
| -- user: 4 | |
| -------------------- | |
| > description | : project meeting |
| > start | : 2 |
| > duration | : 1 |
| > other attendees | : [22, 59] |
| -------------------- | |
| > description | : 1:1 between users 4 and 22 |
| > start | : 3 |
| > duration | : 1 |
| > other attendees | : [22] |
| -- user: 19 | |
| -------------------- | |
| > description | : Focus time for user 19 |
| > start | : 6 |
| > duration | : 1 |
| > other attendees | : [ ] |
| -- user: 22 | |
| -------------------- | |
| > description | : project meeting |
| > start | : 2 |
| > duration | : 1 |
| > other attendees | : [4, 59] |
| -------------------- | |
| > description | : Focus time for user 22 |
| > start | : 6 |
| > duration | : 1 |
| > other attendees | : [ ] |
| -- user: 59 | |
| -------------------- | |
| > description | : project meeting |
| > start | : 2 |
| > duration | : 1 |
| > other attendees | : [4, 22] |
| -------------------- | |
| > description | : standup |
| > start | : 4 |
| > duration | : 3 |
| > other attendees | : [4, 19, 22] |

As shown in the following example output from the computing system 100, the addition of the focus time for user 19 results in the computing system 100 suggesting user 19 skip standup to minimize the opportunity cost (e.g., by maximizing the sum of the importance scores of meetings attended by all of users 4, 19, 22 and 59).

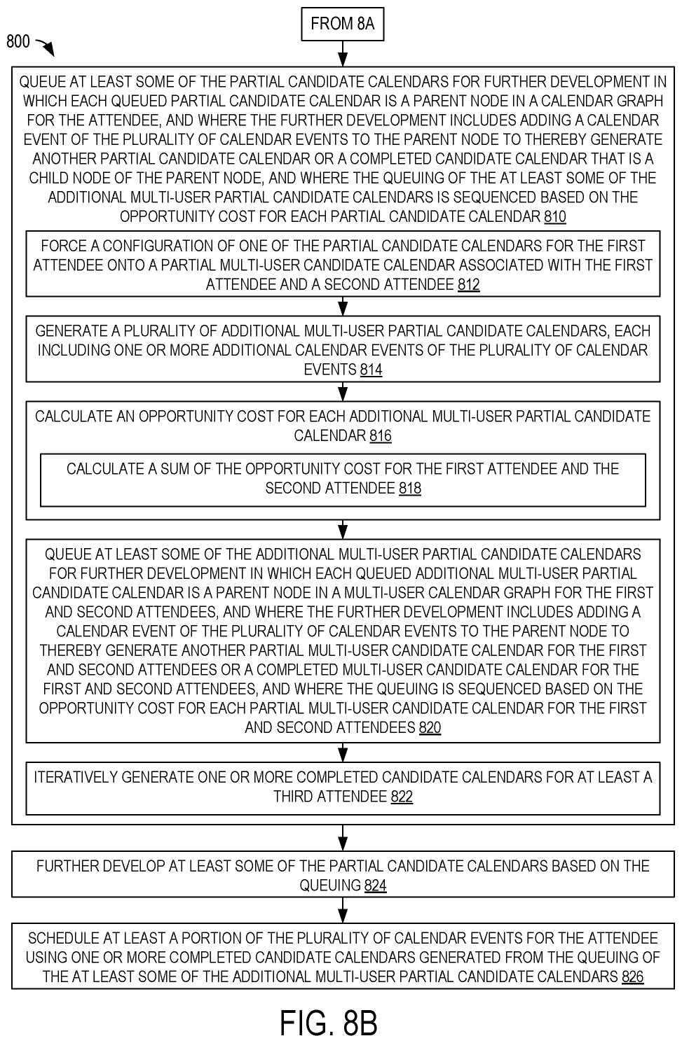

With reference now to FIGS. 8A-8B, a method 800 is described for scheduling one or more of a plurality of calendar events. The following description of the method 800 is provided with reference to the components described above and shown in FIGS. 1-7 and 9. It will be appreciated that the method 800 also may be performed in other contexts using other suitable components.

Referring first to FIG. 8A, at step 802, the method 800 includes receiving, as input, a plurality of calendar events to be scheduled for an attendee. For example, the computing system 100 of FIG. 1 is configured to receive the plurality of calendar events 102 for the attendee 104.

At 804, the method 800 includes generating a plurality of partial candidate calendars for the attendee, each partial candidate calendar including, for each of one or more calendar events of the plurality of calendar events, a timeslot selected from one or more timeslot options for that calendar event. For example, the computing system of FIG. 1 is configured to generate the plurality of partial candidate calendars 110. Each of the partial candidate calendars 110 serves as a starting point for the computing system 100 to generate and compare scheduling configurations for the plurality of calendar events 102.

The method 800 includes, at 806, calculating an opportunity cost for each partial candidate calendar. In some examples, as indicated at 808, each calendar event of the plurality of calendar events is associated with an importance score for the attendee, and calculating the opportunity cost for each partial candidate calendar includes determining a sum of the importance scores of each calendar event not scheduled for the attendee, less the importance score of each calendar event scheduled for the attendee. The opportunity cost thus indicates a relative impact (in terms of the relative importance of the attendee being present) of the attendee skipping one or more of the calendar events.

Referring now to FIG. 8B, the method 800 includes, at step 810, queueing at least some of the partial candidate calendars for further development. Each queued partial candidate calendar is a parent node in a calendar graph for the attendee. The further development includes adding a calendar event of the plurality of calendar events to the parent node to thereby generate another partial candidate calendar or a completed candidate calendar that is a child node of the parent node. The queuing of the at least some of the additional multi-user partial candidate calendars is sequenced based on the opportunity cost for each partial candidate calendar. Sequencing the queue based upon the opportunity cost enables the computing system to prioritize child nodes that lead to lower opportunity cost solutions than other child nodes. The computing system may skip generating the other child nodes that lead to higher-opportunity-cost solutions than the prioritized child nodes. This results in a smaller number of child nodes that are processed and stored in the memory of the computing system than traversing the calendar graph by brute force.

In some examples, at steps 812-822, the method 800 is extended to schedule one or more calendar events for a plurality of attendees. At 812, the method 800 includes, in some examples, forcing a configuration of one of the partial candidate calendars for the first attendee onto a partial multi-user candidate calendar associated with the first attendee and a second attendee. In this manner, the selected one of the partial candidate calendars for the first attendee serves as a template to recursively schedule one or more calendar events for at least the second attendee.

At 814, in some examples, the method 800 includes generating a plurality of additional multi-user partial candidate calendars for the first and second attendees, each including, in addition to calendar events of the forced configuration, one or more additional calendar events of the plurality of calendar events. For example, FIG. 6 shows an example of an additional multi-user partial candidate calendar 186 including one or more additional calendar events 188. As described above, each of the additional multi-user partial candidate calendars serves as a starting point for the computing system to generate and compare scheduling configurations for the first attendee and the second attendee.

In some examples, at 816, the method 800 includes calculating an opportunity cost for each additional multi-user partial candidate calendar. At 818, in some examples, calculating the opportunity cost for each additional partial candidate calendar includes calculating a sum of the opportunity cost for the first attendee and the second attendee. In this manner, the opportunity cost reflects the relative importance of each calendar event to each attendee.

In some examples, at 820, the method 800 includes queueing at least some of the additional multi-user partial candidate calendars for further development. Each queued additional multi-user partial candidate calendar is a parent node in a multi-user calendar graph for the first and second attendees. The further development includes adding a calendar event of the plurality of calendar events to the parent node to thereby generate another partial multi-user candidate calendar for the first and second attendees or a completed multi-user candidate calendar for the first and second attendees. The queuing is sequenced based on the opportunity cost for each partial multi-user candidate calendar for the first and second attendees. In this manner, one or more completed multi-user candidate calendars are generated without requiring every possible permutation of the plurality of calendar events to be processed and/or stored in the memory of the computing system.

At 822, in some examples, the method 800 includes iteratively generating one or more completed candidate calendars for at least a third attendee. For example, the computing system 100 of FIG. 1 may generate multi-user candidate calendars to schedule at least a portion of the plurality of calendar events 102 and/or any other suitable calendar events (e.g., the one or more additional calendar events 176) for at least the third attendee 198 of FIG. 7. In this manner, the computing system 100 is configured to resolve scheduling conflicts between three or more attendees based upon the opportunity cost.

At 824, the method 800 includes further developing at least some of the partial candidate calendars based on the queuing. Next, at 826, the method 800 includes scheduling at least a portion of the plurality of calendar events for the attendee using one or more completed candidate calendars generated from the queuing of the at least some of the additional multi-user partial candidate calendars. For example, the one or more completed candidate calendars 160 of FIG. 1 may be sorted by their opportunity cost 152, and the top-k configuration 170 may be selected to schedule at least the portion of the plurality of calendar events 102. In this manner, scheduling conflicts between calendar events may be resolved based upon their opportunity cost to one or more attendees.

The above-described systems and methods may be used to schedule one or more of a plurality of calendar events for one or more attendees. Opportunity cost is used as a heuristic for a path search algorithm to navigate a calendar graph of calendar event permutations for each attendee and evaluate one or more completed candidate calendars. For a plurality of users, the above-described systems and methods generalize from the single attendee as a foundation to treat each additional attendee recursively. In this manner, scheduling conflicts are resolved based upon the relative importance of each calendar event to each attendee. In addition, the path search algorithm identifies the one or more completed candidate calendars without requiring the exploration of every possible permutation of the plurality of calendar events. This reduces processing time and memory utilization relative to analyzing the plurality of calendar events by brute force.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the processes described above. Computing system 900 is shown in simplified form. Computing system 900 can embody the computing system 100 described above. Computing system 900 can take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 904, and a non-volatile storage device 906. Computing system 900 can optionally include a display subsystem 908, input subsystem 910, communication subsystem 912, and/or other components not shown in earlier figures.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor can include one or more physical processors (hardware) configured to execute software instructions. Additionally or alternatively, the logic processor can include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the logic processors to implement the methods and processes described herein. When such methods and processes are implemented, the state of non-volatile storage device 906 may be transformed—e.g., to hold different data.

Non-volatile storage device 906 can include physical devices that are removable and/or built in. Non-volatile storage device 906 can include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 906 can include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 can include physical devices that include random access memory. Volatile memory 904 is typically utilized by logic processor 902 to temporarily store information during processing of software instructions. It will be appreciated that volatile memory 904 typically does not continue to store instructions when power is cut to the volatile memory 904.

Aspects of logic processor 902, volatile memory 904, and non-volatile storage device 906 may be integrated together into one or more hardware-logic components. Such hardware-logic components can include field-programmable gate arrays (FPGAs), program- and application-specific integrated circuits (PASIC/ASICs), program- and application-specific standard products (PSSP/ASSPs), SOC, and complex programmable logic devices (CPLDs), for example.

The term “program” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 906, using portions of volatile memory 904. It will be understood that different programs may be instantiated from the same application, service, code block, object, library, routine, API, function, etc. Likewise, the same program may be instantiated by different applications, services, code blocks, objects, routines, APIs, functions, etc. The term “program” can encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included display subsystem 908 may be used to present a visual representation of data held by non-volatile storage device 906. The visual representation can take the form of a graphical user interface (GUI). As the herein described methods and processes change the data held by the non-volatile storage device, and thus transform the state of the non-volatile storage device, the state of display subsystem 908 can likewise be transformed to visually represent changes in the underlying data. Display subsystem 908 can include one or more display devices utilizing virtually any type of technology. Such display devices may be combined with logic processor 902, volatile memory 904, and/or non-volatile storage device 906 in a shared enclosure, or such display devices may be peripheral display devices.

When included, input subsystem 910 can comprise or interface with one or more user-input devices such as a keyboard, mouse, touch screen, or game controller. In some embodiments, the input subsystem can comprise or interface with selected natural user input (NUI) componentry. Such componentry may be integrated or peripheral, and the transduction and/or processing of input actions may be handled on- or off-board. Example NUI componentry can include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 can include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem can allow computing system 900 to send and/or receive messages to and/or from other devices via a network such as the Internet.

The following paragraphs provide additional support for the claims of the subject application. One aspect provides a computing system, comprising: a processor; and a memory storing instructions executable by the processor to, receive, as input, a plurality of calendar events to be scheduled for an attendee; generate a plurality of partial candidate calendars for the attendee, each partial candidate calendar including, for each of one or more calendar events of the plurality of calendar events, a timeslot selected from one or more timeslot options for that calendar event; calculate an opportunity cost for each partial candidate calendar; queue at least some of the partial candidate calendars for further development in which each queued partial candidate calendar is a parent node in a calendar graph for the attendee, and where the further development includes adding a calendar event of the plurality of calendar events to the parent node to thereby generate another partial candidate calendar or a completed candidate calendar that is a child node of the parent node, and where the queuing is sequenced based on the opportunity cost for each partial candidate calendar; further develop at least some of the partial candidate calendars based on the queuing; and schedule at least a portion of the plurality of calendar events for the attendee using one or more completed candidate calendars generated from the queuing. In some examples, each calendar event of the plurality of calendar events is additionally or alternatively associated with an importance score for the attendee. In some examples, the opportunity cost for each partial candidate calendar additionally or alternatively includes a sum of the importance scores of each calendar event not scheduled for the attendee, less the importance score of each calendar event scheduled for the attendee. In some examples, the instructions are additionally or alternatively executable to scale the importance score for a calendar event having a plurality of different timeslot options. In some examples, the queuing is additionally or alternatively sequenced based upon an A*algorithm. In some examples, the instructions are additionally or alternatively executable to fraction a calendar event that conflicts with another calendar event. In some examples, the instructions are additionally or alternatively executable to output, for each calendar event not scheduled for the attendee, a prompt for additional time slots. In some examples, each partial candidate calendar and each completed candidate calendar additionally or alternatively include a binary tree representing the scheduled calendar events. In some examples, the attendee is a first attendee and the instructions are additionally or alternatively executable to: force a configuration of one of the partial candidate calendars for the first attendee onto a partial multi-user candidate calendar associated with the first attendee and a second attendee; generate a plurality of additional multi-user partial candidate calendars for the first and second attendees, each including, in addition to calendar events of the forced configuration, one or more additional calendar events of the plurality of calendar events; calculate an opportunity cost for each additional multi-user partial candidate calendar; and queue at least some of the additional multi-user partial candidate calendars for further development in which each queued additional multi-user partial candidate calendar is a parent node in a multi-user calendar graph for the first and second attendees, and where the further development of the additional multi-user partial candidate calendars includes adding a calendar event of the plurality of calendar events to the parent node to thereby generate another partial multi-user candidate calendar for the first and second attendees or a completed multi-user candidate calendar for the first and second attendees, and where the queuing of the at least some of the additional multi-user partial candidate calendars is sequenced based on the opportunity cost for each partial multi-user candidate calendar for the first and second attendees. In some examples, the instructions executable to calculate the opportunity cost for each additional partial candidate calendar are additionally or alternatively executable to calculate a sum of the opportunity cost for the first attendee and the second attendee. In some examples, the instructions are additionally or alternatively executable to iteratively generate one or more completed candidate calendars for at least a third attendee. In some examples, the instructions are additionally or alternatively executable to extract one or more attendee identifiers from the plurality of calendar events for the first attendee; obtain one or more other calendar events associated with at least the second attendee; and extract one or more other attendee identifiers from the one or more other calendar events.

Another aspect provides, at a computing device, a method for scheduling one or more of a plurality of calendar events, the method comprising: receiving, as input, the plurality of calendar events to be scheduled for an attendee; generating a plurality of partial candidate calendars for the attendee, each partial candidate calendar including, for each of one or more calendar events of the plurality of calendar events, a timeslot selected from one or more timeslot options for that calendar event; calculating an opportunity cost for each partial candidate calendar; queueing at least some of the partial candidate calendars for further development in which each queued partial candidate calendar is a parent node in a calendar graph for the attendee, and where the further development includes adding a calendar event of the plurality of calendar events to the parent node to thereby generate another partial candidate calendar or a completed candidate calendar that is a child node of the parent node, and where the queuing is sequenced based on the opportunity cost for each partial candidate calendar; further developing at least some of the partial candidate calendars based on the queuing; and scheduling at least a portion of the plurality of calendar events for the attendee using one or more completed candidate calendars generated from the queuing. In some examples, each calendar event of the plurality of calendar events is additionally or alternatively associated with an importance score for the attendee, and calculating the opportunity cost for each partial candidate calendar additionally or alternatively includes determining a sum of the importance scores of each calendar event not scheduled for the attendee, less the importance score of each calendar event scheduled for the attendee. In some examples, the attendee is additionally or alternatively a first attendee, and the method additionally or alternatively includes: forcing a configuration of one of the partial candidate calendars for the first attendee onto a partial multi-user candidate calendar associated with the first attendee and a second attendee; generating a plurality of additional multi-user partial candidate calendars for the first and second attendees, each including, in addition to calendar events of the forced configuration, one or more additional calendar events of the plurality of calendar events; calculating an opportunity cost for each additional multi-user partial candidate calendar; and queueing at least some of the additional multi-user partial candidate calendars for further development in which each queued additional multi-user partial candidate calendar is a parent node in a multi-user calendar graph for the first and second attendees, and where the further development includes adding a calendar event of the plurality of calendar events to the parent node to thereby generate another partial multi-user candidate calendar for the first and second attendees or a completed multi-user candidate calendar for the first and second attendees, and where the queuing of the additional multi-user partial candidate calendars is sequenced based on the opportunity cost for each partial multi-user candidate calendar for the first and second attendees. In some examples, calculating the opportunity cost for each additional partial candidate calendar additionally or alternatively includes calculating a sum of the opportunity cost for the first attendee and the second attendee. In some examples, the method additionally or alternatively includes iteratively generating one or more completed candidate calendars for at least a third attendee.

Another aspect provides a computing system, comprising: a processor; and a memory storing instructions executable by the processor to, receive, as input, a plurality of calendar events to be scheduled for a first attendee; generate a plurality of partial candidate calendars for the first attendee, each partial candidate calendar including, for each of one or more calendar events of the plurality of calendar events, a timeslot selected from one or more timeslot options for that calendar event; calculate an opportunity cost for each partial candidate calendar; queue at least some of the partial candidate calendars for further development in which each queued partial candidate calendar is a parent node in a calendar graph for the first attendee, and where the further development includes adding a calendar event of the plurality of calendar events to the parent node to thereby generate another partial candidate calendar that is a child node of the parent node, and where the queuing is sequenced based on the opportunity cost for each partial candidate calendar; further develop at least some of the partial candidate calendars based on the queuing; force a configuration of one of the partial candidate calendars for the first attendee onto a partial multi-user candidate calendar associated with the first attendee and a second attendee; generate a plurality of additional multi-user partial candidate calendars for the first and second attendees, each including, in addition to calendar events of the forced configuration, one or more additional calendar events of the plurality of calendar events; calculate an opportunity cost for each additional multi-user partial candidate calendar; queue at least some of the additional multi-user partial candidate calendars for further development in which each queued additional multi-user partial candidate calendar is a parent node in a multi-user calendar graph for the first and second attendees, and where the further development includes adding a calendar event of the plurality of calendar events to the parent node to thereby generate another partial multi-user candidate calendar for the first and second attendees or a completed multi-user candidate calendar for the first and second attendees, and where the queuing of the additional multi-user partial candidate calendars is sequenced based on the opportunity cost for each partial multi-user candidate calendar for the first and second attendees; and schedule at least a portion of the plurality of calendar events for the first and second attendees using one or more completed multi-user candidate calendars generated from the queuing of the additional multi-user partial candidate calendars. In some examples, the instructions executable to calculate the opportunity cost for each additional partial candidate calendar additionally or alternatively include instructions executable to calculate a sum of the opportunity cost for the first attendee and the second attendee. In some examples, the instructions are additionally or alternatively executable to iteratively generate one or more completed candidate calendars for at least a third attendee.

It will be understood that the configurations and/or approaches described herein are exemplary in nature, and that these specific embodiments or examples are not to be considered in a limiting sense, because numerous variations are possible. The specific routines or methods described herein may represent one or more of any number of strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

Further, it will be appreciated that the terms “includes,” “including,” “has,” “contains,” variants thereof, and other similar words used in either the detailed description or the claims are intended to be inclusive in a manner similar to the term “comprising” as an open transition word without precluding any additional or other elements.

1. A computing system, comprising:
a processor; and
a memory storing instructions executable by the processor to,
receive, as input, a plurality of calendar events to be scheduled for an attendee;
generate a plurality of partial candidate calendars for the attendee, each partial candidate calendar including, for each of one or more calendar events of the plurality of calendar events, a timeslot selected from one or more timeslot options for that calendar event;
calculate an opportunity cost for each partial candidate calendar;
queue at least some of the partial candidate calendars for further development in which each queued partial candidate calendar is a parent node in a calendar graph for the attendee, and where the further development includes adding a calendar event of the plurality of calendar events to the parent node to thereby generate another partial candidate calendar or a completed candidate calendar that is a child node of the parent node, and where the queuing is sequenced based on the opportunity cost for each partial candidate calendar;
further develop at least some of the partial candidate calendars based on the queuing; and
schedule at least a portion of the plurality of calendar events for the attendee using one or more completed candidate calendars generated from the queuing.

2. The computing system of claim 1, wherein each calendar event of the plurality of calendar events is associated with an importance score for the attendee.

3. The computing system of claim 2, wherein the opportunity cost for each partial candidate calendar includes a sum of the importance scores of each calendar event not scheduled for the attendee, less the importance score of each calendar event scheduled for the attendee.

4. The computing system of claim 2, wherein the instructions are further executable to scale the importance score for a calendar event having a plurality of different timeslot options.

5. The computing system of claim 1, wherein the queuing is sequenced based upon an A*algorithm.

6. The computing system of claim 1, wherein the instructions are further executable to fraction a calendar event that conflicts with another calendar event.

7. The computing system of claim 1, wherein the instructions are further executable to output, for each calendar event not scheduled for the attendee, a prompt for additional time slots.

8. The computing system of claim 1, wherein each partial candidate calendar and each completed candidate calendar includes a binary tree representing the scheduled calendar events.

9. The computing system of claim 1, wherein the attendee is a first attendee and wherein the instructions are further executable to:
force a configuration of one of the partial candidate calendars for the first attendee onto a partial multi-user candidate calendar associated with the first attendee and a second attendee;
generate a plurality of additional multi-user partial candidate calendars for the first and second attendees, each including, in addition to calendar events of the forced configuration, one or more additional calendar events of the plurality of calendar events;
calculate an opportunity cost for each additional multi-user partial candidate calendar; and
queue at least some of the additional multi-user partial candidate calendars for further development in which each queued additional multi-user partial candidate calendar is a parent node in a multi-user calendar graph for the first and second attendees, and where the further development of the additional multi-user partial candidate calendars includes adding a calendar event of the plurality of calendar events to the parent node to thereby generate another partial multi-user candidate calendar for the first and second attendees or a completed multi-user candidate calendar for the first and second attendees, and where the queuing of the at least some of the additional multi-user partial candidate calendars is sequenced based on the opportunity cost for each partial multi-user candidate calendar for the first and second attendees.

10. The computing system of claim 9, wherein the instructions executable to calculate the opportunity cost for each additional partial candidate calendar include instructions executable to calculate a sum of the opportunity cost for the first attendee and the second attendee.

11. The computing system of claim 9, wherein the instructions are further executable to iteratively generate one or more completed candidate calendars for at least a third attendee.

12. The computing system of claim 9, wherein the instructions are further executable to:
extract one or more attendee identifiers from the plurality of calendar events for the first attendee;
obtain one or more other calendar events associated with at least the second attendee; and
extract one or more other attendee identifiers from the one or more other calendar events.

13. At a computing device, a method for scheduling one or more of a plurality of calendar events, the method comprising:
receiving, as input, the plurality of calendar events to be scheduled for an attendee;
generating a plurality of partial candidate calendars for the attendee, each partial candidate calendar including, for each of one or more calendar events of the plurality of calendar events, a timeslot selected from one or more timeslot options for that calendar event;
calculating an opportunity cost for each partial candidate calendar;
queueing at least some of the partial candidate calendars for further development in which each queued partial candidate calendar is a parent node in a calendar graph for the attendee, and where the further development includes adding a calendar event of the plurality of calendar events to the parent node to thereby generate another partial candidate calendar or a completed candidate calendar that is a child node of the parent node, and where the queuing is sequenced based on the opportunity cost for each partial candidate calendar;
further developing at least some of the partial candidate calendars based on the queuing; and
scheduling at least a portion of the plurality of calendar events for the attendee using one or more completed candidate calendars generated from the queuing.

14. The method of claim 13, wherein each calendar event of the plurality of calendar events is associated with an importance score for the attendee, and wherein calculating the opportunity cost for each partial candidate calendar includes determining a sum of the importance scores of each calendar event not scheduled for the attendee, less the importance score of each calendar event scheduled for the attendee.

15. The method of claim 13, wherein the attendee is a first attendee, and the method further comprises:
forcing a configuration of one of the partial candidate calendars for the first attendee onto a partial multi-user candidate calendar associated with the first attendee and a second attendee;
generating a plurality of additional multi-user partial candidate calendars for the first and second attendees, each including, in addition to calendar events of the forced configuration, one or more additional calendar events of the plurality of calendar events;
calculating an opportunity cost for each additional multi-user partial candidate calendar; and
queueing at least some of the additional multi-user partial candidate calendars for further development in which each queued additional multi-user partial candidate calendar is a parent node in a multi-user calendar graph for the first and second attendees, and where the further development includes adding a calendar event of the plurality of calendar events to the parent node to thereby generate another partial multi-user candidate calendar for the first and second attendees or a completed multi-user candidate calendar for the first and second attendees, and where the queuing of the additional multi-user partial candidate calendars is sequenced based on the opportunity cost for each partial multi-user candidate calendar for the first and second attendees.

16. The method of claim 15, wherein calculating the opportunity cost for each additional partial candidate calendar includes calculating a sum of the opportunity cost for the first attendee and the second attendee

17. The method of claim 15, further comprising iteratively generating one or more completed candidate calendars for at least a third attendee.

18. A computing system, comprising:
a processor; and
a memory storing instructions executable by the processor to,
receive, as input, a plurality of calendar events to be scheduled for a first attendee;
generate a plurality of partial candidate calendars for the first attendee, each partial candidate calendar including, for each of one or more calendar events of the plurality of calendar events, a timeslot selected from one or more timeslot options for that calendar event;
calculate an opportunity cost for each partial candidate calendar;
queue at least some of the partial candidate calendars for further development in which each queued partial candidate calendar is a parent node in a calendar graph for the first attendee, and where the further development includes adding a calendar event of the plurality of calendar events to the parent node to thereby generate another partial candidate calendar that is a child node of the parent node, and where the queuing is sequenced based on the opportunity cost for each partial candidate calendar;
further develop at least some of the partial candidate calendars based on the queuing;
force a configuration of one of the partial candidate calendars for the first attendee onto a partial multi-user candidate calendar associated with the first attendee and a second attendee;
generate a plurality of additional multi-user partial candidate calendars for the first and second attendees, each including, in addition to calendar events of the forced configuration, one or more additional calendar events of the plurality of calendar events;
calculate an opportunity cost for each additional multi-user partial candidate calendar;
queue at least some of the additional multi-user partial candidate calendars for further development in which each queued additional multi-user partial candidate calendar is a parent node in a multi-user calendar graph for the first and second attendees, and where the further development includes adding a calendar event of the plurality of calendar events to the parent node to thereby generate another partial multi-user candidate calendar for the first and second attendees or a completed multi-user candidate calendar for the first and second attendees, and where the queuing of the additional multi-user partial candidate calendars is sequenced based on the opportunity cost for each partial multi-user candidate calendar for the first and second attendees;
further develop at least some of the additional multi-user partial candidate calendars based on the queuing; and
schedule at least a portion of the plurality of calendar events for the first and second attendees using one or more completed multi-user candidate calendars generated from the queuing of the additional multi-user partial candidate calendars.

19. The computing system of claim 18, wherein the instructions executable to calculate the opportunity cost for each additional partial candidate calendar include instructions executable to calculate a sum of the opportunity cost for the first attendee and the second attendee.

20. The computing system of claim 18, wherein the instructions are further executable to iteratively generate one or more completed candidate calendars for at least a third attendee.
